(19) United States
(12) Patent Application Publication
(10) Pub. No.: US 2020/0387517 A1
(43) Pub. Date: Dec. 10, 2020

(54) SEARCH RESULT PAGE RANKING OPTIMIZATION

(71) Applicant: Microsoft Technology Licensing, LLC, Redmond, WA (US)

(72) Inventors: Shen Huang, San Jose, CA (US); Huan Van Hoang, San Jose, CA (US); Yongzheng Zhang, San Jose, CA (US); Chi-Yi Kuan, Fremont, CA (US)

(21) Appl. No.: 16/430,966

(22) Filed: Jun. 4, 2019

(51) Int. Cl. G06F 16/2457; G06F 16/9532; G06F 16/957; G06F 16/9536; G06F 16/951

(52) U.S. Cl. CPC G06F 16/24578; G06F 16/9532; G06F 16/951; G06F 16/9536; G06F 16/9577

(57) ABSTRACT

Disclosed are systems, methods, and non-transitory computer-readable media for search result page ranking optimization. When generating a search result page, a search result optimization system generates links to other related search result pages and adds them to the generates search result page. Adding the generates links enables internet search engines to discover additional search results pages, as well as increases their search ranking. The search result optimization system generates the links based on entity values extracted from the search results page. For example, the search result optimization system extracts entity values based on filter categories available for the search results included in the search result page as well as historical search behavior indicating a number of times that users have selected to filter search results based on the identified filter categories.

### TECHNICAL FIELD

An embodiment of the present subject matter relates generally to search result pages and, more specifically, to a search result page ranking optimization.

### BACKGROUND

Internet search engines provide search results based on webpages found across a variety of websites. For example, a search query executed by an internet search engine may provide separate search results from different websites. In contrast, some online services may provide internal search engines that provide search results based on the data maintained by the online service. For example, an online service providing job listings may include a search engine that allows users to search the job listings hosted by the online service. As another example, an online service that offers items for purchase may include a search engine that allows users to search the items listed for sale. An online service may desire to have their internal search result pages be included in response to a similar search of an internet search engine. For example, it may be desirable that a search result page of an online service's internal search be included prominently in the search results returned from a similar search query executed on an internet search engine. Accomplishing, this however is difficult, as these search result pages are generated dynamically in response to an executed search query. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system that provides search result page ranking optimization, according to some example embodiments.

FIG. 2 is a block diagram of an online service, according to some example embodiments.

FIG. 3 is a block diagram of a search result optimization system, according to some example embodiments.

FIG. 4 is a block diagram of an entity extraction module, according to some example embodiments.

FIG. 5 is a flowchart showing an example method of providing search result page ranking optimization, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for search result page ranking optimization. Some online services provide internal search functionality that allows users to execute a search query exclusively on data maintained by the online service. The search results are therefore limited to data maintained by the online service, rather than data maintained by multiple online services as provided by a general internet search engine (e.g., GOOGLE). As an example, internal search functionality of an online service that provides job listings may allow users to execute a search query of the job listings maintained by the online service. As another example, internal search functionality of an online service that offers an online marketplace may allow users to execute a search query of the products listed for sale on the online marketplace.

The internal search functionality provided by an online service enables a user to enter search terms and execute a search query based on the search terms. The online service generates a search result page that includes a listing of search results from the search query. A user may scroll through the search results presented in the search results page and select a result to access its corresponding webpage. To further aid the user in identifying relevant results, the generated search result page may include selectable filters. For example, the online service may provide one or more predetermined filter categories (e.g., location) that each include multiple subcategories (e.g., San Francisco, New York, Los Angeles, etc.). A user can select one or more of the subcategories to filter the search results accordingly. For example, a user may select the subcategory San Francisco to filter the search results of a job search to present the job listing that are available in San Francisco.

An online service may desire to have their internal search result page be included in a set of search results for a similar search executed using a general internet search engine. For example, an online service that provides job listings may desire to have their internal search result page for the search query “engineering jobs” be included in the list of search results provided by a general internet search engine in response to a similar or same search query (e.g., engineering jobs, software engineering jobs, etc.).

General internet search engines use web crawlers to identify and catalog webpages. The cataloged data is used for providing search results. Web crawlers start with a list of Uniform Resource Locators (URLs), access the corresponding webpages and catalog the included data. The web crawlers identify and follow web link included in the webpages to access and catalog additional webpages. A general search engine may rank their search results based on the number of discovered web links to a given webpage. For example, a webpage that has a relatively high number of web links pointing to it may be ranked higher in search results than a webpage that has a relatively lower number of web links pointing to it.

The search result pages provided by an online service are generated dynamically. That is, the search result pages are generated in response to an executed search query. To allow for a web crawler to access the search results pages, an online service includes web links in its webpages that cause execution of the search queries using the online service's internal search functionality. This results in generation of a search results page, which the web crawler can then catalog. In addition to providing access to the search result pages, the web links may also increase the ranking of the search result page in the search results provided by a general internet search engine.

Current systems include either static web links in their webpages or dynamically generated web links based on standardized data that can be pulled from the URL of the webpage. For example, the URL may include entity values encoded in the URL, which can be used to generate a new web link to a search result page. One issue with this approach is that it provides access to only a limited number of search results pages. For example, static web links are linked to an individual search results page (e.g., always execute the same search query) and the dynamic links are limited to the entity values embedded in the URL. Another issue with the current dynamic approach is that it is limited to use with webpages that include URLs that are embedded with entity values and therefore cannot be used when the URL of a webpage is not embedded with entity values.

The search result optimization system of the present disclosure alleviates these issues by extracting entity values from the content of the webpage, rather than relying on entity values embedded in the URL. For example, the search result optimization system uses data gathered from the search results and historical search behavior data to determine the entity values. The search result optimization system uses the determined entity values to generate web links to other search result pages, which are them embedded into the generated search result page. This provides the benefit of generating dynamic web links from webpages that do not include URLs embedded with standardized entity values, as well as provides for web links to a larger grouping of search result pages. As a result, a web crawler will access and catalog a greater number of search result pages of the online service, thereby increasing the likelihood of the search results pages being presented in the search results of the generally online search engine.

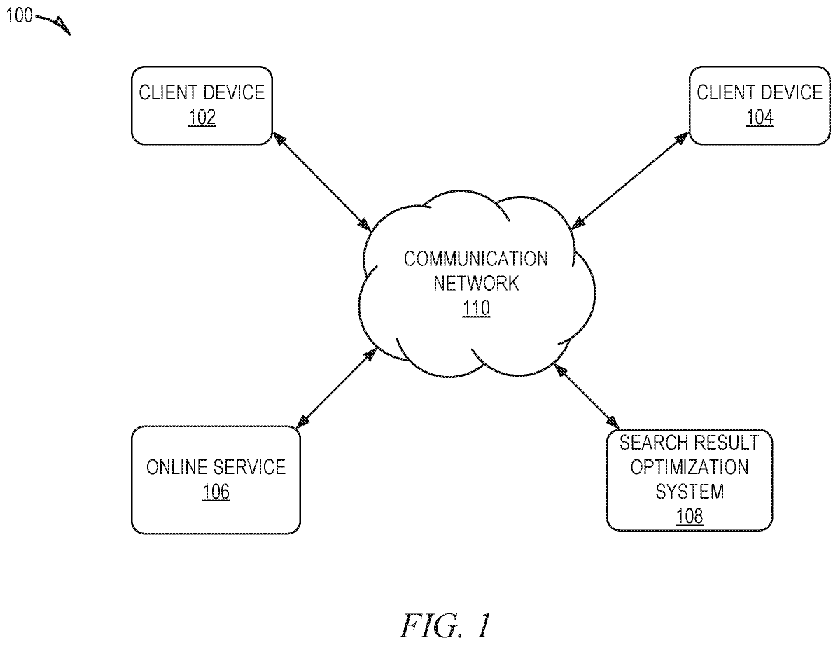

FIG. 1 shows an example system 100 that provides search result page ranking optimization, according to some example embodiments. As shown, multiple devices (i.e., client device 102, client device 104, online service 106, and search result optimization system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

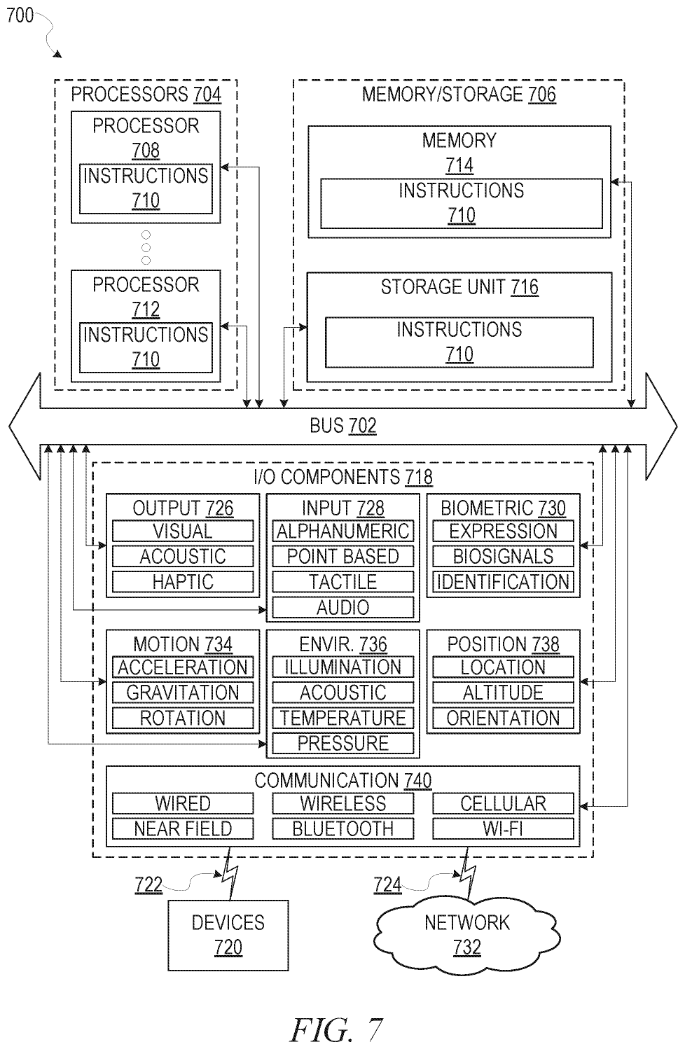

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online service 106 to utilize the services provided by the online service 106. Users communicate with and utilize the functionality of the online service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online service 106 may concurrently accept connections from and interact with any number of client devices 102, 104. The online service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online service 106 via a client-side application installed on the client devices 102 and 104. In some embodiments, the client-side application includes a component specific to the online service 106. For example, the component may be a stand-alone application, one or more application plug-ins, and/or a browser extension. However, the users may also interact with the online service 106 via a third-party application, such as a web browser, that resides on the client devices 102 and 104 and is configured to communicate with the online service 106. In either case, the client-side application presents a user interface (UI) for the user to interact with the online service 106. For example, the user interacts with the online service 106 via a client-side application integrated with the file system or via a webpage displayed using a web browser application.

The online service 106 is one or more computing devices configured to provide a service that is accessible online. The service may be any type of service, such as a banking service, online social networking service, data management service, job posting service, online marketplace, etc. For example, the online service 106 may provide a job posting service that allows employers to post listings for job openings and allows users to view the posted job listing and apply.

As part of its provided service, the online service 106 includes internal search functionality that allows users to execute a search query exclusively on data maintained by the online service 106. The search results are therefore limited to data maintained by the online service 106, rather than data maintained by multiple online services as provided by a general internet search engine (e.g., GOOGLE). As an example, internal search functionality of an online service 106 that provides job listings may allow users to execute a search query of the job listings maintained by the online service. As another example, internal search functionality of an online service 106 that offers an online marketplace may allow users to execute a search query of the products listed for sale on the online marketplace.

The internal search functionality provided by the online service 106 enables a user to enter search terms and execute a search query based on the search terms. For example, a user uses a client device 102, 104 to enter search terms and execute a search query. In response, the online service 106 generates a search result page that includes a listing of search results from the search query. A user may then use their client device 102, 104 to scroll through the search results presented in the search results page and select a search result to access its corresponding webpage. To further aid the user in identifying relevant results, the generated search result page may include selectable filters. For example, the online service 106 may provide one or more predetermined filter categories (e.g., location) that each include multiple subcategories (e.g., San Francisco, New York, Los Angeles, etc.). A user can select one or more of the subcategories to filter the search results accordingly. For example, a user may select the subcategory San Francisco to filter the search results of a job search to present the job listing that are available in San Francisco.

The online service 106 utilizes the functionality of the search result optimization system 108 to have their internal search result page be included in a set of search results for a similar search executed using a general internet search engine. As a result, the search result page generated by the online service 106 for a search query (e.g., engineering jobs) will be included in the list of search results provided by a general internet search engine in response to a similar or same search query (e.g., engineering jobs, software engineering jobs, etc.).

Although the search result optimization system 108 and the online service 106 are shown as separate entities, this is just for ease of explanation and is not meant to be limiting. In some embodiments, the search result optimization system 108 is incorporated as part of the online service 106.

The search result optimization system 108 is one or more computing device configured to extract entity values from a search result page and generate links to other search result pages based on the extracted entity values. The generated links may then be included into the search result page from which the entity value was extracted. The generates links included in a search result page of the online service 106 allow an internet web crawler to continuously access additional search result pages of the online service 106, thereby increasing the likelihood that the search result pages will be included in the search results of a general internet search engine.

The search result optimization system 108 extracts the entity values based on filter categories available in the search result page as well as historical search behavior indicating a number of times that users have selected to filter search results based on the identified filter categories. Some of the filter categories provided by the online service 106 may correspond to the entity values used by the search result optimization system 108. For example, a search query for job listings may include filter categories such as location, job title, salary range, etc., that can be used to generate another related search query. The search result optimization system 108 leverages filter category data provided by the online service 106 to determine the entity values. The filter category data includes a list of each filter category, the subcategories of each filter category, as well result count values indicating a number of search results that fall within each subcategory of a filter category. For example, the filter category data may indicate that the filter category “Location” includes the subcategories “San Francisco” and “Los Angeles,” and the result count values may indicate that 25 of the search results are within San Francisco and 15 of the search results are within Los Angeles.

The search result optimization system 108 uses the result count values corresponding to the subcategories to rank the subcategories within a filter category. For example, the search result optimization system 108 ranks the subcategories within filter category from the subcategory with the highest count value to the subcategory with the lowest count value. Ranking the subcategories for a filter category based on the result count values results in a result count ranking for the subcategories for each filter category.

The search result optimization system 108 also generates a second ranking of the subcategories based on historical search behavior data. The historical search data includes data describing user search history, including search terms entered, filter categories selected, search results selected, etc. The search result optimization system 108 uses the historical search data to determine selection count values corresponding to the subcategories of a filter category. The selection count values indicate the number of times that each subcategory was previously selected by users to filter search results. The search result optimization system 108 uses the selection count values to rank the subcategories of the filter category, resulting in a selection county ranking of the subcategories of the filter category. For example, the search result optimization system 108 ranks the subcategories for a filter category from the subcategory with the highest selection count value to the subcategory with the lowest selection count value.

The search result optimization system 108 uses the result count ranking and the selection count ranking of the subcategories of a filter category to determine an entity value for an entity corresponding to the filter category. For example, the search result optimization system 108 may determine an entity value for the entity “Location” based on the result count ranking and the selection count ranking of the subcategories of the filter category “Location.” The search result optimization system 108 determines the entity value by initially determining a cumulative ranking of the subcategories based on the result count ranking and the selection count ranking. For example, the search result optimization system 108 may combine the two rankings to create the cumulative ranking, including applying different weights to the two rankings. The search result optimization system 108 then determines the entity value based on the cumulative ranking, for example, by selecting the subcategory that is ranked highest in the cumulative ranking.

The search result optimization system 108 may perform this operation based on multiple filter categories to extract multiple entity values. The search result optimization system 108 may then generated a web link to a search result page based on the extracted entity values. For example, the search result optimization system 108 may generate a web link that causes a search query based on the extracted entity values, such as Location, Job Title, etc.

In some embodiments, the search result optimization system 108 may generate multiple web links based on the extracted entity values. For example, the search result optimization system 108 may extract multiple entity values for each entity based on the corresponding cumulative ranking. The search result optimization system 108 may then generate web links based on the various entity values. For example, the search result optimization system 108 may select the two highest ranked subcategories from each cumulative ranking, resulting in two separate sets of entity values. The search result optimization system 108 may then generate a web link based on each set of entity values.

The search result optimization system 108 provides the generated web links to the online service 106, which then includes the generated web links into the search result page. The search result optimization system 108 performs the process of generating web links for each search result page generated by the online service 106. Accordingly, each search result page generated by the online service 106 includes web links to other search result pages, thereby allowing a web crawler to continuously access additional search results pages generated by the online service 106. This may increase the likelihood that a search result page of the online service 106 will be presented as a search result of a search query generated by a general online search engine.

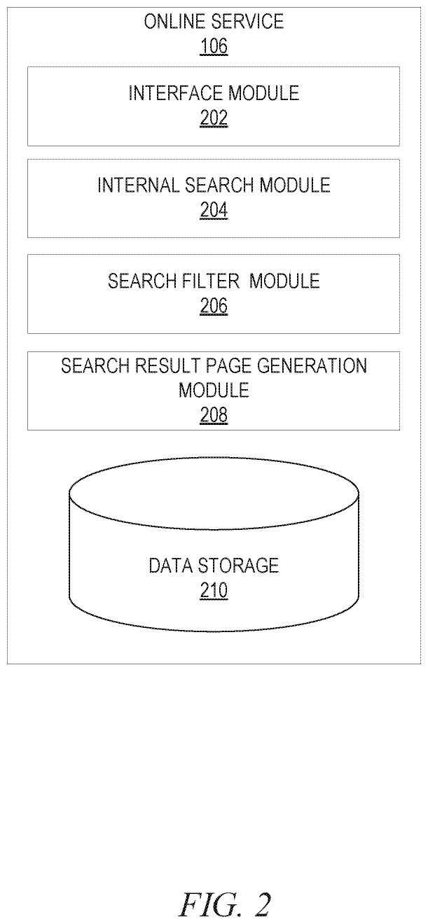

FIG. 2 is a block diagram of an online service 106, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the online service 106 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the online service 106 includes an interface module 202, an internal search module 204, a search filter module 206, a search result page generation module 208, and a data storage 210.

The interface module 202 presents a user interface that allows a user to utilize the functionality of the online service 106. For example, the user interface presents data provided by the online service 106 on a display of a user's client device 102, 104. The user interface also includes user interface elements (e.g., buttons, text fields, etc.) that allow a user to provide input, such as make selection, enter data, etc., which are sent from the user's client device 102, 104 to the online service 106, causing a change in the data presented within the user interface. For example, the online service 106 provides updated data to the user's client device 102, 104 based on the input received via the user interface elements included in the user interface.

The internal search module 204 provides search functionality based on data maintained by the online service 106. For example, the internal search module 204 receives search terms including one or more keywords from a user and executes a search query based on the provided search terms. That is, the internal search module 204 searches data stored in the data storage 210 based on the provided search terms. For example, the internal search module 204 searches for content that includes and/or is tagged with one or more of the keywords included in the search term. The internal search module 204 generates a set of ranked search results as a result of the executed search query.

The search filter module 206 generates a set of filter categories and corresponding subcategories for the search results. The filter categories may be based on a predetermined list of filter categories, such as Location, Title, Price, Salary, etc. The search filter module 206 determines the result count value for each subcategory, which indicates the number of search results that fall within the respective subcategory. The resulting filter categories and corresponding subcategories may be used by a user to filter the search results from a search query. For example, a user may select one or more subcategories to filter the search results to include only the search results that fall within the selected subcategories.

The search result page generation module 208 generates a search result page based on the executed search query. The search result page includes a listing of the search results generated by the internal search module 204 in response to a search query, as well as the filter categories and corresponding subcategories generated by the search filter module 206. The search result page generated by the search result page generation module 208 also includes one or more web links generated by the search result optimization system 108. For example, the search result page generation module 208 provides the search result optimization system 108 with the search results and filter category data generated by the internal search module 204 and the search filter module 206. In return, the search result optimization system 108 provides the search result page generation module 208 with one or more web links generated based on the search results and filter category data. The web links cause generation of other search result pages generated based on entity values extracted from the search results and filter category data provided to the search result optimization system 108. The search result page generation module 208 includes the provide web links in the generated search result page, which is returned in response to the initiating search query.

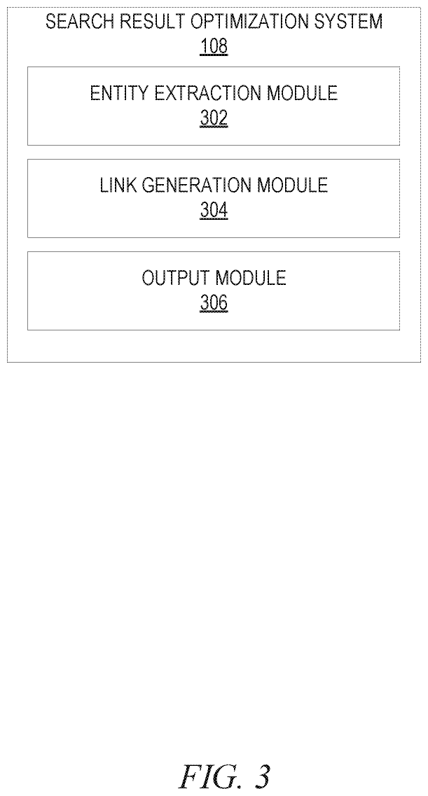

FIG. 3 is a block diagram of a search result optimization system 108, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the search result optimization system 108 to facilitate additional functionality that is not specifically described herein. Furthermore, the various functional modules depicted in FIG. 3 may reside on a single computing device or may be distributed across several computing devices in various arrangements such as those used in cloud-based architectures.

As shown, the search result optimization system 108 includes an entity extraction module 302, a link generation module 304 and an output module 306.

The entity extraction module 302 extracts entity values for one or more predetermined entities. Each predetermined entity is a variable used as a keyword in a search term used to execute a search query. Each predetermined entity may therefore be assigned varying entity values. An example of a predetermined entity is Location, which may have varying values, such as San Francisco, Los Angeles, etc. Another example of a predetermined entity Salary, which may have varying values such as $20,000, $40,000, etc. The entity extraction module 302 extracts the entity values for a predetermined entity based on filter categories generated for a search result page as well as historical search behavior data indicating the number of times that users have selected to filter search results based on the subcategories of the filter categories. For example, the entity extraction module 302 generates a result count ranking of the subcategories of a filter category based on the number of search results that fall within each respective subcategory of the filter category. The entity extraction module 302 also generates a selection count ranking for the subcategories of the filter category based on the number of times users have previously selected to filer search results based on the respective subcategories.

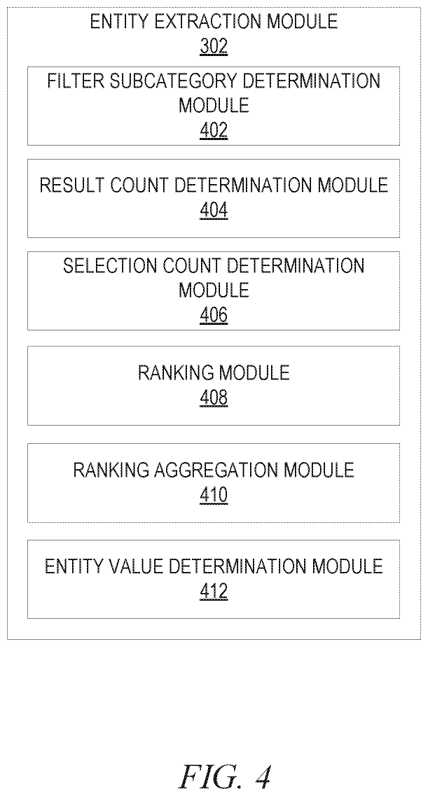

The entity extraction module 302 then determines an entity value based on the resulting result count ranking and the selection count ranking for the subcategories of the filter category. For example, the entity extraction module 302 generates a cumulative ranking of the subcategories of the filter category based on the result count ranking and the selection count ranking. The entity extraction module 302 then selects an entity value based on the cumulative ranking. The functionality of the entity extraction module 302 is discussed in greater detail below in the discussion of FIG. 4.

The link generation module 304 generates a web link based on entity values determined by the entity extraction module 302. The resulting web link causes generation of a search result page based on the entity values determined by the entity extraction module 302. For example, the entity extraction module 302 may extract entity values for entities such as Job Title (e.g., Engineer) and Location (e.g., San Francisco). The link generation module 304 uses the entity values to generate a link that causes execution of a search query based on the entity values for Job Title (e.g., Engineer) and Location (e.g., San Francisco).

In some embodiments, the link generation module 304 generates multiple web links based on the entity values determined from a single search result page. For example, the entity extraction module 302 may generated multiple sets of entity values and the link generation module 304 may generate web links based on each set of entity values. As another example, the link generation module 304 may generate multiple web links based on varying combinations of the entity values provided by the entity extraction module 302.

The output module 306 provides the web links generated by the link generation module 304 to the online service 106. The online service 106 may then include the generated links into the search result page from which the entity values were extracted. As a result, the search result page will include links to other similar or related search results pages.

FIG. 4 is a block diagram of an entity extraction module 302, according to some example embodiments. To avoid obscuring the inventive subject matter with unnecessary detail, various functional components (e.g., modules) that are not germane to conveying an understanding of the inventive subject matter have been omitted from FIG. 4. However, a skilled artisan will readily recognize that various additional functional components may be supported by the entity extraction module 302 to facilitate additional functionality that is not specifically described herein. Furthermore, the various functional modules depicted in FIG. 4 may reside on a single computing device or may be distributed across several computing devices in various arrangements such as those used in cloud-based architectures.

As shown, the entity extraction module 302 includes a filter subcategory determination module 402, a result count determination module 404, a selection count determination module 406, a ranking module 408, a ranking aggregation module 410, and an entity value determination module 412.

The filter subcategory determination module 402 determines the subcategories for a filter category. The filter subcategory determination module 402 may determine the subcategories for a filter category based on the filter category data provided to the search result optimization system 108 by the online service 106. For example, the search filter module 206 generates the filter category data, which is then provided to the search result optimization system 108.

The result count determination module 404 determines the result count value for each subcategory of the filter category. The result count value for a subcategory indicates the number of search results from the search query that fall within the respective subcategory. The result count determination module 404 may determine the result count values from the filter category data, which may include the result count values. Alternatively, the result count determination module 404 may determine the result count values based on an analysis of the search results. For example, the result count determination module 404 may analyze data included in the search result for data indicating which subcategory the respective search result falls within.

The selection count determination module 406 determines a selection count value for each of the subcategories of a filter category. The selection count value indicates the number of times users previously selected to filter search results based on the subcategory. This may be based on all historical search behavior data available to the selection count determination module 406 or, alternatively, a subset of the historical search behavior data. For example, the selection count value may be based on historical search behavior data within a given time frame, such as during a previous day, week, etc. The selection count determination module 406 gathers the historical search behavior data from the data storage 210.

The ranking module 408 generates a result count ranking and selection count ranking of the subcategories of a filter category. The ranking module 408 generates the result count ranking based on the result count value for each subcategory, such as by ranking the subcategories from the subcategory with the highest count value to the lowest count value. The ranking module 408 generates the selection count ranking based on the selection count value for each subcategory, such as by ranking the subcategories from the subcategory with the highest selection count value to the lowest selection count value.

The ranking aggregation module 410 generates a cumulative ranking for the subcategories of a filter category based on the result count ranking and selection count ranking of the subcategories of a filter category. For example, the ranking aggregation module 410 may combine the two rankings to create the cumulative ranking, including applying different weights to the two rankings.

The entity value determination module 412 determines an entity value based on the cumulative ranking for the subcategories of the filter category. For example, the entity value determination module 412 may select the highest ranked subcategory in the cumulative ranking as the entity value. As another example, the entity value determination module 412 may select multiple entity values from the cumulative ranking, such as selecting the top two or three subcategories as entity values.

While the functionality of the entity extraction module 302 is described in relation to subcategories of a single filter category, this is just for ease of explanation and is not meant to be limiting. The entity extraction module 302 may extract entity values from multiple filter categories generated for a set of search results. Accordingly, the entity extraction module 302 may extract entity values for multiple entities from a single search result page.

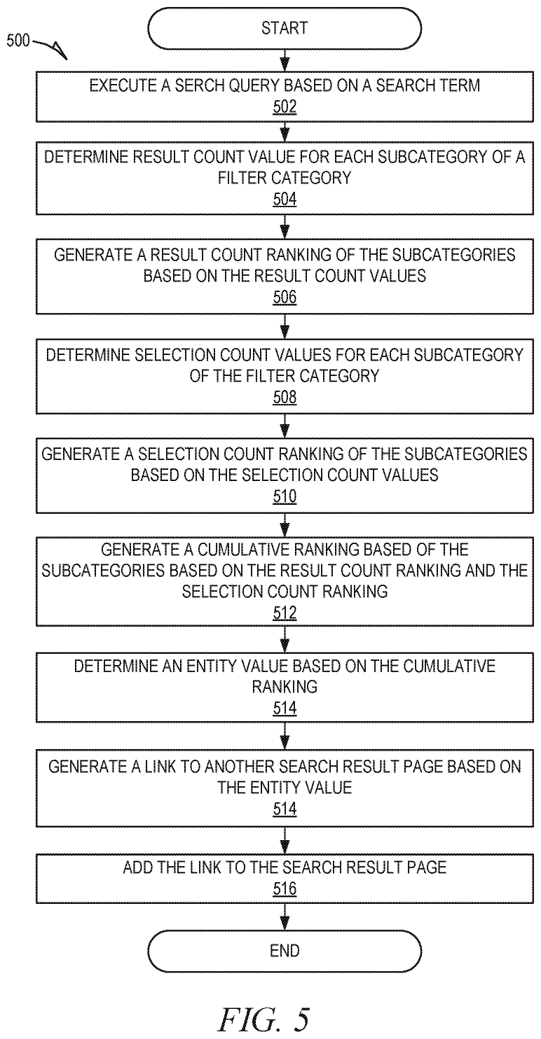

FIG. 5 is a flowchart showing an example method 500 of providing search result page ranking optimization, according to certain example embodiments. The method 500 may be embodied in computer readable instructions for execution by one or more processors such that the operations of the method 500 may be performed in part or in whole by the search result optimization system 108; accordingly, the method 500 is described below by way of example with reference thereto. However, it shall be appreciated that at least some of the operations of the method 500 may be deployed on various other hardware configurations and the method 500 is not intended to be limited to the search result optimization system 108.

At operation 502, the internal search module 204 executes a search query based on a search term. The internal search module 204 provides search functionality based on data maintained by the online service 106. For example, the internal search module 204 receives search terms including one or more keywords from a user and executes a search query based on the provided search terms. That is, the internal search module 204 searches data stored in the data storage 210 based on the provided search terms. For example, the internal search module 204 searches for content that includes and/or is tagged with one or more of the keywords included in the search term. The internal search module 204 generates a set of ranked search results as a result of the executed search query.

At operation 504, the result count determination module 404 determines a result count value for each subcategory of a filter category. The result count value for a subcategory indicates the number of search results from the search query that fall within the respective subcategory. The result count determination module 404 may determine the result count values from the filter category data, which may include the result count values. Alternatively, the result count determination module 404 may determine the result count values based on an analysis of the search results. For example, the result count determination module 404 may analyze data included in the search result for data indicating which subcategory the respective search result falls within.

At operation 506, the ranking module 408 generates a result count ranking of the subcategories based on the result count values. The ranking module 408 generates the result count ranking based on the result count value for each subcategory, such as by ranking the subcategories from the subcategory with the highest count value to the lowest count value.

At operation 508, the selection count determination module 406 determines selection count values for each subcategory of the filter category. The selection count value indicates the number of times users previously selected to filter search results based on the subcategory. This may be based on all historical search behavior data available to the selection count determination module 406 or, alternatively, a subset of the historical search behavior data. For example, the selection count value may be based on historical search behavior data within a given time frame, such as during a previous day, week, etc. The selection count determination module 406 gathers the historical search behavior data from the data storage 210.

At operation 510, the ranking module 408 determines a selection count ranking of the subcategories based on the selection count values. The ranking module 408 generates the selection count ranking based on the selection count value for each subcategory, such as by ranking the subcategories from the subcategory with the highest selection count value to the lowest selection count value.

At operation 512, the ranking aggregation module 410 generates a cumulative ranking based on the subcategories based on the result count ranking and the selection count ranking. For example, the ranking aggregation module 410 may combine the two rankings to create the cumulative ranking, including applying different weights to the two rankings.

At operation 514, the entity determination module 412 determines an entity value based on the cumulative ranking. For example, the entity value determination module 412 may select the highest ranked subcategory in the cumulative ranking as the entity value. As another example, the entity value determination module 412 may select multiple entity values from the cumulative ranking, such as selecting the top two or three subcategories as entity values.

At operation 516, the link generation module 304 generates a link to another search result page based on the entity value. The link generation module 304 generates a web link based on entity values determined by the entity extraction module 302. The resulting web link causes generation of a search result page based on the entity values determined by the entity extraction module 302. For example, the entity extraction module 302 may extract entity values for entities such as Job Title (e.g., Engineer) and Location (e.g., San Francisco). The link generation module 304 uses the entity values to generate a link that causes execution of a search query based on the entity values for Job Title (e.g., Engineer) and Location (e.g., San Francisco).

In some embodiments, the link generation module 304 generates multiple web links based on the entity values determined from a single search result page. For example, the entity extraction module 302 may generated multiple sets of entity values and the link generation module 304 may generate web links based on each set of entity values. As another example, the link generation module 304 may generate multiple web links based on varying combinations of the entity values provided by the entity extraction module 302.

At operation 518, the search result page generation module 208 adds the link to the search result page. The search result page generation module 208 generates a search result page based on the executed search query. The search result page includes a listing of the search results generated by the internal search module 204 in response to a search query, as well as the filter categories and corresponding subcategories generated by the search filter module 206. The search result page generated by the search result page generation module 208 also includes one or more web links generated by the search result optimization system 108. For example, the search result page generation module 208 provides the search result optimization system 108 with the search results and filter category data generated by the internal search module 204 and the search filter module 206. In return, the search result optimization system 108 provides the search result page generation module 208 with one or more web links generated based on the search results and filter category data. The web links cause generation of other search result pages generated based on entity values extracted from the search results and filter category data provided to the search result optimization system 108. The search result page generation module 208 includes the provide web links in the generated search result page, which is returned in response to the initiating search query.

### Software Architecture

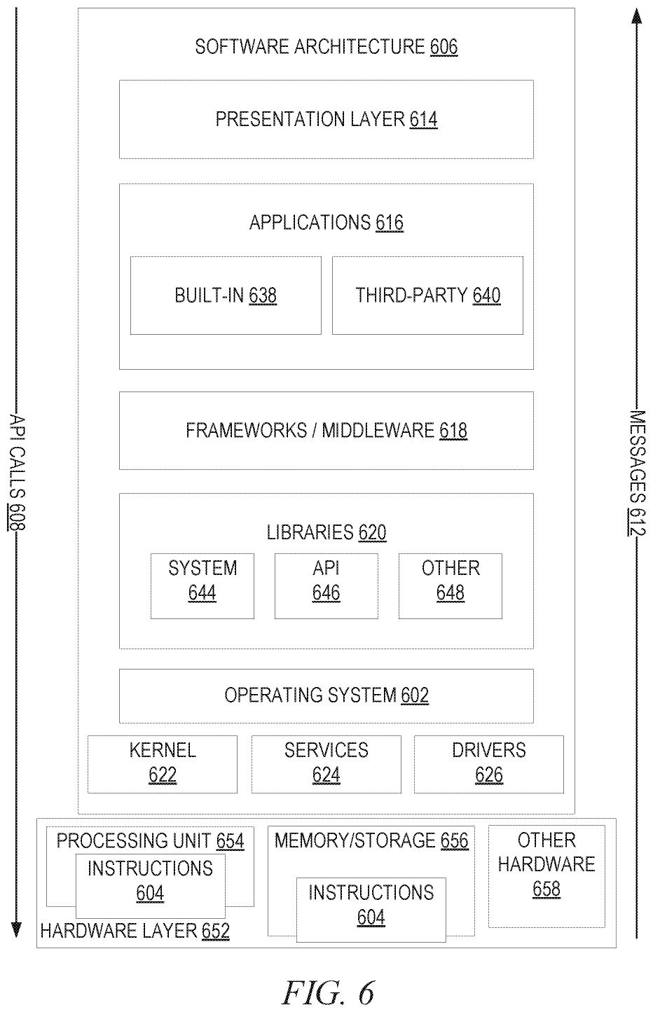

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor 704) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 704 may further be a multi-core processor having two or more independent processors 704 (sometimes referred to as “cores”) that may execute instructions 710 contemporaneously.

What is claimed is:

1. A method comprising:
executing a search query based on a search term, yielding a first search results page including a first set of search results;
for each subcategory from a set of subcategories for a first filter category, determining, based on the first set of search results, a result count value indicating a number of search results from the first set of search results that fall within the respective subcategory for the first filter category, yielding a first set of subcategory result count values for the first filter category;
ranking the set of subcategories for the first filter category based on the first set of subcategory result count values for the first filter category, yielding a result count ranking of the set of subcategories for the first filter category;
for each subcategory from the set of subcategories for the first filter category, determining, based on historical search behavior, a selection count value indicating a number of times that users have selected to filter search results based on the respective subcategory for the first filter category, yielding a first set of subcategory selection count values for the first filter category;
ranking the set of subcategories for the first filter category based on the first set of subcategory selection count values for the first filter category, yielding a selection count ranking of the set of subcategories for the first filter category; and
determining an entity value for a first entity based on the result count ranking of the set of subcategories for the first filter category and the selection count ranking of the set of subcategories for the first filter category.

2. The method of claim 1, wherein determining the entity value for the first entity comprises:
generating a cumulative ranking of the set of subcategories for the first filter category based on the result count ranking of the set of subcategories for the first filter category and the selection count ranking of the set of subcategories for the first filter category; and
selecting the entity value based on the cumulative ranking of the set of subcategories for the first filter;

3. The method of claim 1, further comprising:
determining a second entity value for a second entity based on a result count ranking of a second set of subcategories for a second filter category and a selection count ranking of the second set of subcategories for the second filter category.

4. The method of claim 3, further comprising:
for each subcategory from a second set of subcategories for a second filter category, determining, based on the first set of search results, a result count value indicating a number of search results from the first set of search results that fall within the respective subcategory for the second filter category, yielding a second set of subcategory result count values for the second filter category;
ranking the second set of subcategories for the second filter category based on the second set of subcategory result count values for the second filter category, yielding the result count ranking of the second set of subcategories for the first filter category;
for each subcategory from the second set of subcategories for the first filter category, determining, based on historical search behavior, a selection count value indicating a number of times that users have selected to filter search results based on the respective subcategory for the first filter category, yielding a first set of subcategory selection count values for the first filter category; and
ranking the second set of subcategories for the first filter category based on the first set of subcategory selection count values for the first filter category, yielding the selection count ranking of the set of subcategories for the first filter category.

5. The method of claim 1, further comprising:
generating, based on the entity value for the first entity, a link to a second search results page, the second search results page including a second set of search results generated based on a second search term, the second search term being based on the entity value for the first entity; and
adding the link to the first search results page.

6. The method of claim 1, wherein the search query is executed as a result of activation of a first link included in a second search result page that is different than the first search result page.

7. The method of claim 6, wherein activation of the first link is performed by an internet search engine web crawler.

8. A computing system comprising:
one or more computer processors; and
one or more computer-readable mediums storing instructions that, when executed by the one or more computer processors, cause the computing system to perform operations comprising:
executing a search query based on a search term, yielding a first search results page including a first set of search results;
for each subcategory from a set of subcategories for a first filter category, determining, based on the first set of search results, a result count value indicating a number of search results from the first set of search results that fall within the respective subcategory for the first filter category, yielding a first set of subcategory result count values for the first filter category;
ranking the set of subcategories for the first filter category based on the first set of subcategory result count values for the first filter category, yielding a result count ranking of the set of subcategories for the first filter category;
for each subcategory from the set of subcategories for the first filter category, determining, based on historical search behavior, a selection count value indicating a number of times that users have selected to filter search results based on the respective subcategory for the first filter category, yielding a first set of subcategory selection count values for the first filter category;
ranking the set of subcategories for the first filter category based on the first set of subcategory selection count values for the first filter category, yielding a selection count ranking of the set of subcategories for the first filter category; and
determining an entity value for a first entity based on the result count ranking of the set of subcategories for the first filter category and the selection count ranking of the set of subcategories for the first filter category.

9. The computing system of claim 8, wherein determining the entity value for the first entity comprises:
generating a cumulative ranking of the set of subcategories for the first filter category based on the result count ranking of the set of subcategories for the first filter category and the selection count ranking of the set of subcategories for the first filter category; and
selecting the entity value based on the cumulative ranking of the set of subcategories for the first filter;

10. The computing system of claim 8, the operations further comprising:
determining a second entity value for a second entity based on a result count ranking of a second set of subcategories for a second filter category and a selection count ranking of the second set of subcategories for the second filter category.

11. The computing system of claim 10, the operations further comprising: for each subcategory from a second set of subcategories for a second filter category, determining, based on the first set of search results, a result count value indicating a number of search results from the first set of search results that fall within the respective subcategory for the second filter category, yielding a second set of subcategory result count values for the second filter category;
ranking the second set of subcategories for the second filter category based on the second set of subcategory result count values for the second filter category, yielding the result count ranking of the second set of subcategories for the first filter category;
for each subcategory from the second set of subcategories for the first filter category, determining, based on historical search behavior, a selection count value indicating a number of times that users have selected to filter search results based on the respective subcategory for the first filter category, yielding a first set of subcategory selection count values for the first filter category; and
ranking the second set of subcategories for the first filter category based on the first set of subcategory selection count values for the first filter category, yielding the selection count ranking of the set of subcategories for the first filter category.

12. The computing system of claim 8, the operations further comprising:
generating, based on the entity value for the first entity, a link to a second search results page, the second search results page including a second set of search results generated based on a second search term, the second search term being based on the entity value for the first entity; and
adding the link to the first search results page.

13. The computing system of claim 8, wherein the search query is executed as a result of activation of a first link included in a second search result page that is different than the first search result page.

14. The computing system of claim 13, wherein activation of the first link is performed by an internet search engine web crawler.

15. A non-transitory computer-readable medium storing instructions that, when executed by one or more computer processors of a computing system, cause the computing system to perform operations comprising:
executing a search query based on a search term, yielding a first search results page including a first set of search results;
for each subcategory from a set of subcategories for a first filter category, determining, based on the first set of search results, a result count value indicating a number of search results from the first set of search results that fall within the respective subcategory for the first filter category, yielding a first set of subcategory result count values for the first filter category;
ranking the set of subcategories for the first filter category based on the first set of subcategory result count values for the first filter category, yielding a result count ranking of the set of subcategories for the first filter category;
for each subcategory from the set of subcategories for the first filter category, determining, based on historical search behavior, a selection count value indicating a number of times that users have selected to filter search results based on the respective subcategory for the first filter category, yielding a first set of subcategory selection count values for the first filter category;
ranking the set of subcategories for the first filter category based on the first set of subcategory selection count values for the first filter category, yielding a selection count ranking of the set of subcategories for the first filter category; and
determining an entity value for a first entity based on the result count ranking of the set of subcategories for the first filter category and the selection count ranking of the set of subcategories for the first filter category.

16. The non-transitory computer-readable medium of claim 15, wherein determining the entity value for the first entity comprises:
generating a cumulative ranking of the set of subcategories for the first filter category based on the result count ranking of the set of subcategories for the first filter category and the selection count ranking of the set of subcategories for the first filter category; and
selecting the entity value based on the cumulative ranking of the set of subcategories for the first filter;

17. The non-transitory computer-readable medium of claim 15, the operations further comprising:
determining a second entity value for a second entity based on a result count ranking of a second set of subcategories for a second filter category and a selection count ranking of the second set of subcategories for the second filter category.

18. The non-transitory computer-readable medium of claim 17, the operations further comprising:
for each subcategory from a second set of subcategories for a second filter category, determining, based on the first set of search results, a result count value indicating a number of search results from the first set of search results that fall within the respective subcategory for the second filter category, yielding a second set of subcategory result count values for the second filter category;
ranking the second set of subcategories for the second filter category based on the second set of subcategory result count values for the second filter category, yielding the result count ranking of the second set of subcategories for the first filter category;
for each subcategory from the second set of subcategories for the first filter category, determining, based on historical search behavior, a selection count value indicating a number of times that users have selected to filter search results based on the respective subcategory for the first filter category, yielding a first set of subcategory selection count values for the first filter category; and
ranking the second set of subcategories for the first filter category based on the first set of subcategory selection count values for the first filter category, yielding the selection count ranking of the set of subcategories for the first filter category.

19. The non-transitory computer-readable medium of claim 15, the operations further comprising:
generating, based on the entity value for the first entity, a link to a second search results page, the second search results page including a second set of search results generated based on a second search term, the second search term being based on the entity value for the first entity; and
adding the link to the first search results page.

20. The non-transitory computer-readable medium of claim 15, wherein the search query is executed as a result of activation of a first link included in a second search result page that is different than the first search result page, activation of the first link being performed by an internet search engine web crawler.
